(19) United States
(12) Patent Application Publication
(10) Pub. No.: US 2013/0284785 A1
(43) Pub. Date: Oct. 31, 2013

(54) TUNGSTEN CARBIDE RING CRACKER

(71) Applicant: Timothy Lynn Brosius, St. Francis, MN (US)

(72) Inventor: Timothy Lynn Brosius, St. Francis, MN (US)

(21) Appl. No.: 13/459,224

(22) Filed: Apr. 29, 2012

(51) Int. Cl. B26F 3/00; B23P 11/00

(52) U.S. Cl. 225/1; 225/103

(57) ABSTRACT

A ring cracking device can help in the removal of rings, such as tungsten carbide, ceramic, or hardened metal rings, from a wearer's finger. The ring cracking device allows for a quick and safe way to remove a finger ring that will not deform or bend the ring, but only crack the ring under pressure. The ring cracking device includes a pressure point that may be tightened against the ring while the ring is secured in the body of the device.

### BACKGROUND OF THE INVENTION

The present invention relates to ring removal devices and methods and more particularly, to a method and device for removing hardened metal or ceramic material rings, such as tungsten carbide rings.

Tungsten carbide is a relatively new material being used for wedding bands and rings. Proper tools are needed to remove a ring made of this material from a wearer's finger. Doctors and jewelers are currently using hammers, wrenches, pliers, and the like, to remove these rings. This can be quite intimidating to the wearer.

As can be seen, there is a need for an improved method and device to remove rings from a wearer.

### SUMMARY OF THE INVENTION

In one aspect of the present invention, a ring removal device comprises a body having a ring accepting hole formed therethrough, the ring accepting hole adapted to fit a ring therewithin; a pressure point screw threadably engaged with a threaded hole formed through the body, where the threaded hole communicates an exterior off the body with the ring accepting hole; and a pressure point on a first end of the pressure point screw, the pressure point adapted to place pressure on a ring disposed in the ring accepting hole as the pressure point screw is turned in the threaded hole.

In another aspect of the present invention, a ring removal tool for cracking rings comprises a body having a ring accepting hole formed therethrough, the ring accepting hole adapted to fit a ring therewithin; a device steady handle extending from the body; a pressure point screw threadably engaged with a threaded hole formed through the body, where the threaded hole communicates an exterior off the body with the ring accepting hole; a pressure point on a first end of the pressure point screw, the pressure point adapted to place pressure on a ring disposed in the ring accepting hole as the pressure point screw is turned in the threaded hole; and a turn screw handle disposed on a second, opposite end of the pressure point screw, wherein the ring accepting hole has a V-shaped interior opposite the threaded hole, and the ring accepting hole has a groove cut in an interior portion of the ring accepting hole, the groove disposed oppose the threaded hole.

In a further aspect of the present invention, a method for removing a ring from a wearer comprises fitting the ring into a ring accepting hole of a body of a ring removal device; steading the body with a device steady handle extending from the body; turning a pressure point screw through a threaded hole formed in the body to permit the pressure point screw to extend into the ring accepting hole and to permit a pressure point on an end of the pressure point screw to press against the ring; and cracking the ring with pressure applied by the pressure point onto the ring.

These and other features, aspects and advantages of the present invention will become better understood with reference to the following drawings, description and claims.

### BRIEF DESCRIPTION OF THE DRAWINGS

FIG. 1 is a front view of a ring cracker according to an exemplary embodiment of the present invention;

FIG. 2 is a partial perspective view of the ring cracker of FIG. 1, showing a self-centering groove to aid in ring placement;

FIG. 3 is a side view of a turn screw handle of the ring cracker of FIG. 1, showing an optional wrench for increased torque;

FIG. 4 is a top view of the turn screw handle of FIG. 3;

FIG. 5 is a cross-sectional view of the turn screw handle of FIG. 3;

FIG. 6 is a side view of a pressure point screw of the ring cracker of FIG. 1;

FIG. 7 is an end view of the pressure point screw of FIG. 6;

FIG. 8 is a detailed view of the pressure point tip of the pressure point screw of FIG. 6;

FIG. 9 is a side view of the body of the ring cracker of FIG. 1; and

FIG. 10 is a top view of the body of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a ring cracking device that can help in the removal of rings, such as tungsten carbide, ceramic, or hardened metal rings, from a wearer's finger. The ring cracking device allows for a quick and safe way to remove a finger ring that will not deform or bend the ring, but only crack the ring under pressure. The ring cracking device includes a pressure point that may be tightened against the ring while the ring is secured in the body of the device.

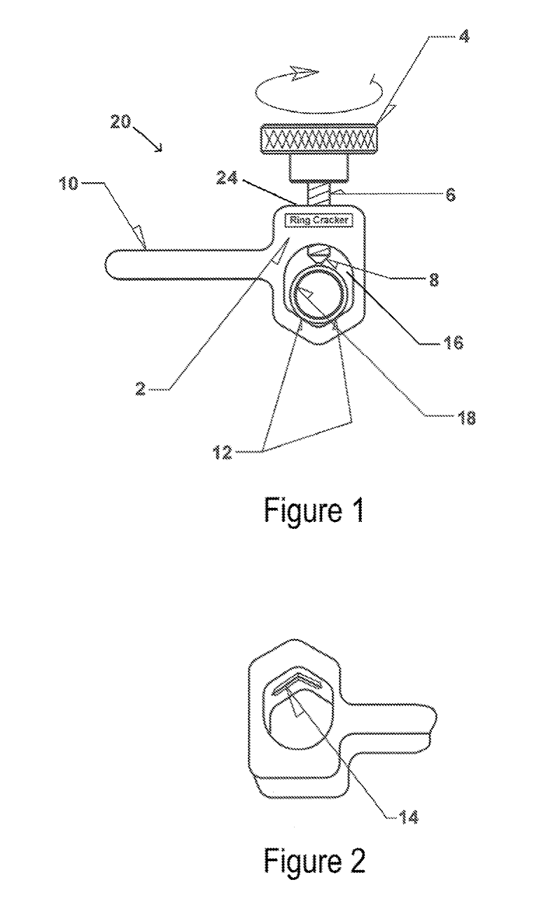

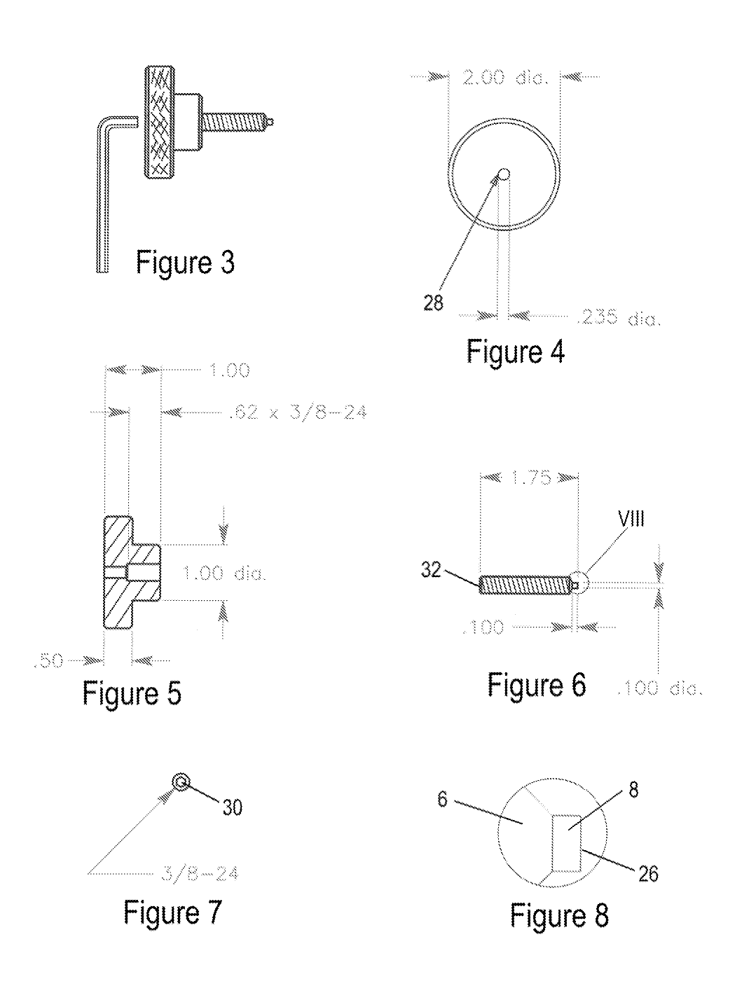

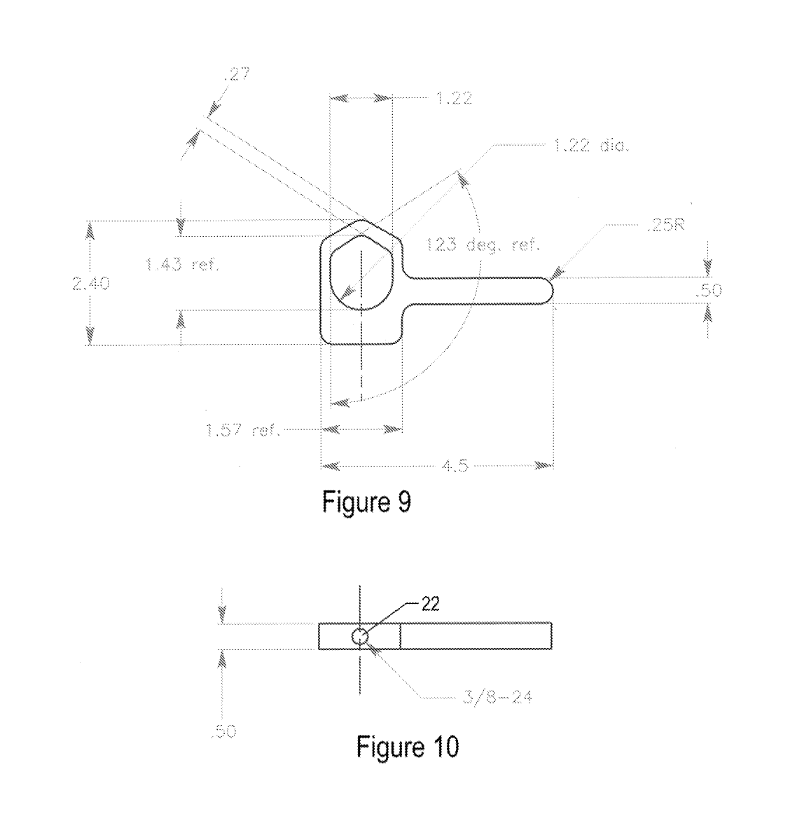

Referring now to FIGS. 1 through 10, a ring cracking device 20 (also referred to as device 20) may include a main body 2 encircling a ring placement hole 16 formed therein to accept a ring 18. A device steady handle 10 may extend from the body to help stabilize the body 2 during use and prevent rotation while applying pressure to a drive screw, as described below.

A threaded hole 22 may be disposed on a top surface 24 of the body 2. A pressure point screw 6 may thread into the threaded hole 22 and extend into the ring placement hole 16. A pressure point 8 may be disposed on the end of the pressure point screw 6. The pressure point 8 may have a flat surface 26 having a diameter from about 0.050 to about 0.200 inch, typically about 0.100 inch. The pressure point 8 may be threaded through the threaded hole 22 to apply pressure to the ring 18 disposed in the ring placement hole 16.

The ring placement hole 16 may be rounded along a top portion thereof, while providing a v-shaped interior 12 along a bottom portion thereof. The valley of the v-shaped interior 12 may be opposite a central axis of the hole 22. This v-shaped interior 12 may be advantageous for keeping the ring 18 centered so that the pressure point 8 of the pressure point screw 6 may provide pressure squarely at a top of the ring 18. The v-shaped interior 12 may include a groove 14 cut therein. The groove 14 may assist in the centering of the ring 18.

A turn screw handle 4 may be disposed on a distal end 32 (relative to the pressure point 8) of the pressure point screw 6. The turn screw handle 4 may have a gripping surface, such as a knurled surface, allowing the user to turn the turn screw handle 4, which, in turn, turns the pressure point screw 6.

The turn screw handle 4 may have a hole 28 formed through a central portion thereof. The hole 28 may permit access to a tool acceptance end 30 of the pressure point screw 6. The tool acceptance end 30 may be, for example, a hexagonal tool acceptance end. A user may insert a tool, such as a hexagonal wrench 34 through the hole 28 to engage the tool acceptance end 30 of the pressure point screw 6, allowing the user to apply increased torque to the pressure point screw 6.

While the drawings show particular dimensions for the device 20, it should be understood that these dimensions are merely exemplary dimensions and they may be modified while retaining the function of the ring cracking device of the present invention. For example, the turn screw handle 4 may be made in various diameters, where a larger diameter may provide greater comfort and control for turning the pressure point screw 6.

The ring cracking device 20 may crack a ring, without bending or deforming the ring. The purchase of tungsten carbide rings has grown to such an extent where about 20% of all bands sold are made of tungsten carbide. Accordingly, there is a need to remove these bands for either simple removal or emergency removal purposes. The ring cracking device 20 can remove a ring with no risk to the finger, resulting in a safe, effective and painless ring removal process.

It should be understood, of course, that the foregoing relates to exemplary embodiments of the invention and that modifications may be made without departing from the spirit and scope of the invention as set forth in the following claims.

What is claimed is:

1. A ring removal device comprising:
a body having a ring accepting hole formed therethrough, the ring accepting hole adapted to fit a ring therewithin;
a pressure point screw threadably engaged with a threaded hole formed through the body, where the threaded hole communicates an exterior off the body with the ring accepting hole; and
a pressure point on a first end of the pressure point screw, the pressure point adapted to place pressure on a ring disposed in the ring accepting hole as the pressure point screw is turned in the threaded hole.

2. The ring removal device of claim 1, further comprising a device steady handle extending from the body.

3. The ring removal device of claim 1, further comprising a turn screw handle disposed on a second, opposite end of the pressure point screw.

4. The ring removal device of claim 3, wherein:
the turn screw handle has a hole formed through a central region thereof; and
a second, opposite end of the pressure point screw includes a tool accepting portion adapted to accept a tool inserted through the hole of the turn screw handle.

5. The ring removal device of claim 1, wherein the ring accepting hole has a V-shaped interior opposite the threaded hole.

6. The ring removal device of claim 1, further comprising a groove cut in an interior portion of the ring accepting hole, the groove disposed oppose the threaded hole.

7. The ring removal tool of claim 1, therein the pressure point has a flat bottom surface with a diameter of about 0.100 inch for engaging the ring.

8. A ring removal tool for cracking rings, comprising:
a body having a ring accepting hole formed therethrough, the ring accepting hole adapted to fit a ring therewithin;
a device steady handle extending from the body;
a pressure point screw threadably engaged with a threaded hole formed through the body, where the threaded hole communicates an exterior off the body with the ring accepting hole;
a pressure point on a first end of the pressure point screw, the pressure point adapted to place pressure on a ring disposed in the ring accepting hole as the pressure point screw is turned in the threaded hole; and
a turn screw handle disposed on a second, opposite end of the pressure point screw, wherein
the ring accepting hole has a V-shaped interior opposite the threaded hole, and
the ring accepting hole has a groove cut in an interior portion of the ring accepting hole, the groove disposed oppose the threaded hole.

9. The ring removal tool of claim 8, wherein:
the turn screw handle has a hole formed through a central region thereof; and
a second, opposite end of the pressure point screw includes a tool accepting portion adapted to accept a tool inserted through the hole of the turn screw handle.

10. A method for removing a ring from a wearer, the method comprising:
fitting the ring into a ring accepting hole of a body of a ring removal device;
steading the body with a device steady handle extending from the body;
turning a pressure point screw through a threaded hole formed in the body to permit the pressure point screw to extend into the ring accepting hole and to permit a pressure point on an end of the pressure point screw to press against the ring; and
cracking the ring with pressure applied by the pressure point onto the ring.
